(19) United States
(12) Patent Application Publication
(10) Pub. No.: US 2005/0272373 A1
(43) Pub. Date: Dec. 8, 2005

(54) Sir measurement device and sir measurement method

(75) Inventor: Taichi Murase, Kanagawa (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD, OSAKA (JP)

(21) Appl. No.: 10/522,900

(22) PCT Filed: Apr. 28, 2004
(86) PCT No.: PCT/JP04/06158

§ 371 Date: Feb. 1, 2005

(30) Foreign Application Priority Data
Jun. 4, 2003 (JP) 2003-159726

(51) Int. Cl. H04B 17/00

(52) U.S. Cl. 455/67.11

(57) ABSTRACT

An SIR calculation section 130 calculates an SIR value D4 after RAKE combining from a desired signal power value for each finger calculated by an RSCP calculation section 110 and an interference signal power value for each finger calculated by an ISCP calculation section 120. An SIR correction section 140 corrects the SIR value D4 using the number of discrete signals used to calculate RSCP, the number of discrete signals used to calculate ISCP and the number of fingers L used for RAKE combining. As a result, even when the number of discrete signals used to calculate RSCP is different from the number of discrete signals used to calculate ISCP, it is possible to realize an SIR measuring apparatus 100 capable of resolving a static error with respect to a theoretical value and realizing measurements at a high degree of accuracy and freedom.

### TECHNICAL FIELD

The present invention relates to an apparatus and method for measuring an SIR after RAKE combining based on a communication scheme which performs RAKE combining such as a CDMA communication system in particular.

### BACKGROUND ART

Conventionally, an SIR (Signal to Interference Ratio) is widely used as an index for performing various types of control such as transmit power in the field of radio communications. For example, a communication system using a CDMA (Code Division Multiple Access) scheme measures an SIR after RAKE combining and controls transmit power based on this measurement result. By so doing, it is possible to control transmit power at each user to a minimum necessary level, suppress interference to other users from each user and obtain desired reception quality (that is, SIR).

According to closed-loop transmit power control of this transmit power control, a receiving side apparatus presets a target SIR as target reception quality and sends a transmit power control signal to a transmission apparatus so that the actually measured SIR approximates to this target reception quality to thereby exercise control of transmit power of the transmission apparatus.

Thus, the SIR is also used as an index for transmit power control, and therefore the measuring accuracy has a large influence on the communication quality. Therefore, various improvements have been conventionally made to measure the SIR with high accuracy.

For example, the Unexamined Japanese Patent Publication No. 2000-252926 (hereinafter referred to as “Patent Document 1”) describes a method of correcting static errors in SIR measurement by carrying out corrections according to the number of discrete signals used for SIR measurement. The method will be explained below.

Assuming that the number of discrete signals used for SIR measurement is N_sir and the square of a mean value of the signals is RSCP (Received Signal Code Power: desired signal power), the ensemble mean value of the RSCP can be expressed by the following expression:

$$\overline{RSCP} = RSCP ( true ) + \frac{{σ}^{2}}{{N}_{—} sir} \qquad ( 1 )$$

Here, the RSCP(true) is a true RSCP of discrete signals and σ² is true ISCP (Interference Signal Code Power: interference signal power). That is, the ensemble mean value of the measured RSCP includes a residual interference component σ²/N_sir. Likewise, when the ISCP (interference power) is calculated from a variance of the discrete signals, the ensemble mean value of the ISCP can be expressed by the following expression:

$$\overline{ISCP} = {σ}^{2} - \frac{{σ}^{2}}{{N}_{—} sir} \qquad ( 2 )$$

That is, the ensemble mean value of the measured ISCP is measured as a value smaller than the true ISCP (σ²) by σ²/N_sir.

Therefore, when the SIR is measured using the RSCP and ISCP, the ensemble mean value of the measured SIR is expressed by the following expression:

$$\overline{SIR} = \frac{\overline{RSCP}}{\overline{ISCP}} = \frac{RSCP ( true ) + \frac{{σ}^{2}}{{N}_{—} sir}}{{σ}^{2} - \frac{{σ}^{2}}{{N}_{—} sir}} = ( \frac{{N}_{—} sir}{{N}_{—} sir - 1} ) \cdot SIR ( true ) + \frac{1}{{N}_{—} sir - 1} \qquad ( 3 )$$

Here, the SIR(true) is a true SIR to be calculated and can be expressed by the following expression:

$$SIR ( true ) = \frac{RSCP ( true )}{{σ}^{2}} \qquad ( 4 )$$

Therefore, from Expressions (3) and (4), the true SIR(true) can be calculated by carrying out a correction according to the following expression:

$$SIR ( true ) = \frac{{N}_{—} sir - 1}{{N}_{—} sir} \cdot SIR - \frac{1}{{N}_{—} sir} \qquad ( 5 )$$

Patent Document 1 describes a technology of correcting a static error of the SIR value by carrying out the correction in Expression (5) and improving the measuring accuracy of the SIR value.

However, in a system carrying out RAKE combining like a CDMA communication, when an SIR value after RAKE combining is calculated from RSCP and ISCP values obtained for each finger and the SIR value is corrected, the above described conventional SIR measuring method and apparatus cannot correct the static error with respect to a theoretical value correctly and is still insufficient in measuring an SIR value at a high degree of accuracy.

As is also evident from Expression (5), the conventional SIR measuring method carries out a correction only based on the number of measured signals used to calculate an SIR and does not take into consideration a case where there is a difference in the number of measured signals between the RSCP and ISCP. For this reason, there is a disadvantage that the degree of freedom in SIR measurement and the apparatus configuration tends to decrease.

### DISCLOSURE OF INVENTION

It is an object of the present invention to provide an SIR measuring apparatus and method capable of measuring an SIR after RAKE combining at a high degree of accuracy and having a high degree of freedom in measurements.

This object can be attained by correcting the SIR after RAKE combining calculated from a desired signal power value for each finger and interference signal power value for each finger according to the number of discrete signals used to calculate a desired signal power value for each finger, the number of discrete signals used to calculate an interference signal power value for each finger and the number of fingers subjected to RAKE combining.

### BRIEF DESCRIPTION OF DRAWINGS

FIG. 1 is a block diagram showing the overall configuration of an SIR measuring apparatus according to an Embodiment of the present invention;

FIG. 2 is a block diagram showing the configuration of an SIR calculation section;

FIG. 3 is a block diagram showing the configuration of an SIR correction section according to Embodiment 1;

FIG. 4 illustrates variables used in the embodiment;

FIG. 5 illustrates the result of an experiment making a comparison between an SIR before correction, SIR after correction according to a conventional technique and SIR after correction according to the embodiment of the present invention under a condition with the number of fingers set to 4;

FIG. 6 illustrates the result of an experiment making a comparison between an SIR before correction, SIR after correction according to a conventional technique and SIR after correction according to the embodiment of the present invention under a condition with the number of fingers set to 2; and

FIG. 7 is a block diagram showing the configuration of an SIR correction section according to Embodiment 2.

### BEST MODE FOR CARRYING OUT THE INVENTION

With reference now to the attached drawings, embodiments of the present invention will be explained in detail below.

### Embodiment 1

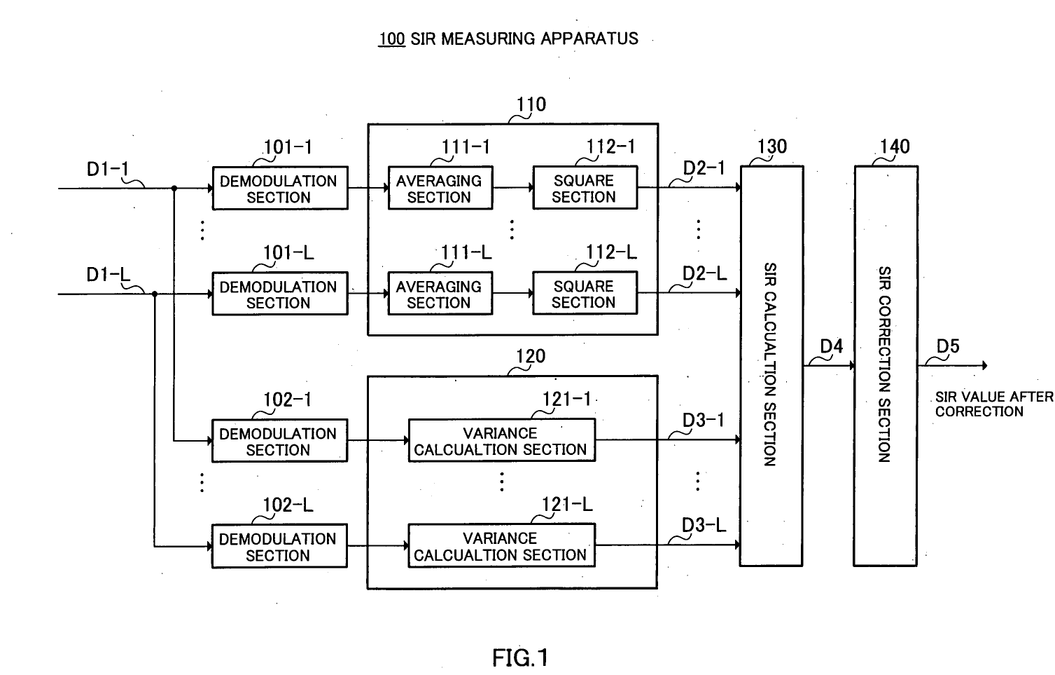

In FIG. 1, reference numeral 100 denotes an SIR measuring apparatus according to an Embodiment of the present invention as a whole, which is roughly divided into an RSCP calculation section 110 that calculates RSCP (desired signal power) of each finger (the number of fingers is assumed to be L in this embodiment), an ISCP calculation section 120 that calculates an ISCP (interference signal power) of each finger, an SIR calculation section 130 that calculates an SIR after RAKE combining from the desired signal power value D2 and interference signal power value D3 calculated by the RSCP calculation section 110 and ISCP calculation section 120, and an SIR correction section 140 that corrects the SIR calculated by the SIR calculation section 130.

The SIR measuring apparatus 100 inputs despread signals D1-1 to D1-L of respective fingers of a received signal to demodulation sections 101-1 to 101-L, 102-1 to 102-L. The respective demodulation sections 101-1 to 101-L, 102-1 to 102-L remove information modulation components from the despread signals D1-1 to D1-L of the respective fingers. More specifically, when an information component is I+jQ and a received signal is i+jq, (i+jq)(I−jQ) is calculated. Thus, the demodulation sections 101-1 to 101-L, 102-1 to 102-L extract only known signal components from the despread signals D1-1 to D1-L and output. The outputs of the demodulation sections 101-1 to 101-L are sent to the RSCP calculation section 110, while the outputs of the demodulation sections 102-1 to 102-L are sent to the ISCP calculation section 120.

The respective averaging sections 111-1 to 111-L of the RSCP calculation section 110 calculate a mean value of demodulated signals of a finite number of symbols. The square sections 112-1 to 112-L square the mean values obtained by the respective averaging sections 111-1 to 111-L. In this way, the RSCP calculation section 110 calculates RSCP values D2-1 to D2-L of the respective fingers and sends these RSCP values D2-1 to D2-L-to the SIR calculation section 130.

The variance calculation sections 121-1 to 121-L of the ISCP calculation section 120 calculate variances of demodulated signals of a finite number of symbols and send these variances to the SIR calculation section 130 as ISCP values D3-1 to D3-L of the respective fingers. This variance can be calculated by subtracting the square of a mean value from a square mean value. This processing is expressed by the following expression:

$$Variance = \{ {\sum }_{m = 1}^{n} \{ {a ( m )}^{2} \} \} / n - {\{ \{ {\sum }_{m = 1}^{n} a ( m ) \} / n \}}^{2} \qquad ( 6 )$$

In Expression (6), suppose a is a demodulated signal, m is a symbol number and n is the number of signals measured.

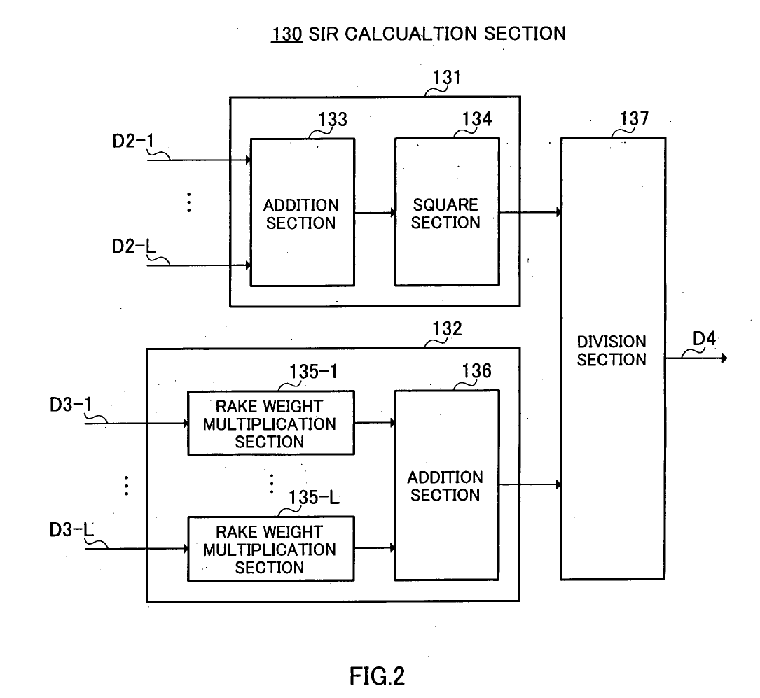

The SIR calculation section 130 calculates an SIR value D4 after RAKE combining from the RSCP values D2-1 to D2-L of the respective fingers and ISCP values D3-1 to D3-L of the respective fingers. FIG. 2 shows an example of the configuration of the SIR calculation section 130. The SIR calculation section 130 is constructed of a RAKE RSCP calculation section 131 and a RAKE ISCP calculation section 132. The RAKE RSCP calculation section 131 adds up the RSCP values D2-1 to D2-L for the respective-fingers at an addition section 133, squares the RSCP addition value of the respective fingers at a square section 134 and outputs the result as an RSCP value after RAKE combining.

On the other hand, the RAKE ISCP calculation section 132 multiplies the ISCP values D3-1 to D3-L for the respective fingers by the square of a RAKE weight at RAKE weight multiplication sections 135-1 to 135-L, adds up the ISCP values multiplied by the square of the RAKE weight for the respective fingers at an addition section 136 and outputs the result as an ISCP value after RAKE combining.

The SIR calculation section 130 finally divides the RSCP value after RAKE combining by the ISCP value after RAKE combining at a division section 137 and outputs the division result as an SIR value D4. The SIR calculation section 130 can have any configuration if it can at least calculate the SIR value D4 after RAKE combining from the RSCP values D2-1 to D2-L for the respective fingers and ISCP values D3-1 to D3-L for the respective fingers.

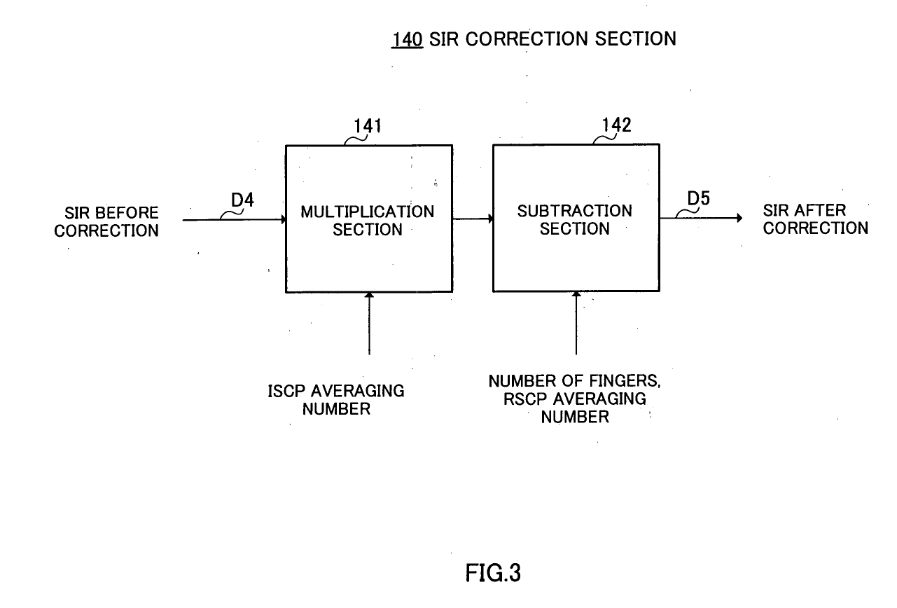

FIG. 3 shows the configuration of the SIR correction section 140 of this embodiment. The SIR correction section 140 inputs an SIRD4 before correction output from the SIR calculation section 130 to a multiplication section 141. The multiplication section 141 multiplies the SIR value D4 before correction by a value corresponding to the averaging number used for the ISCP calculation. A subtraction section 142 subtracts a value corresponding to the number of fingers L used for RAKE combining and the averaging number used for the RSCP calculation from the SIR value multiplied by the ISCP averaging number and outputs the subtraction result as an SIR (D5) after correction.

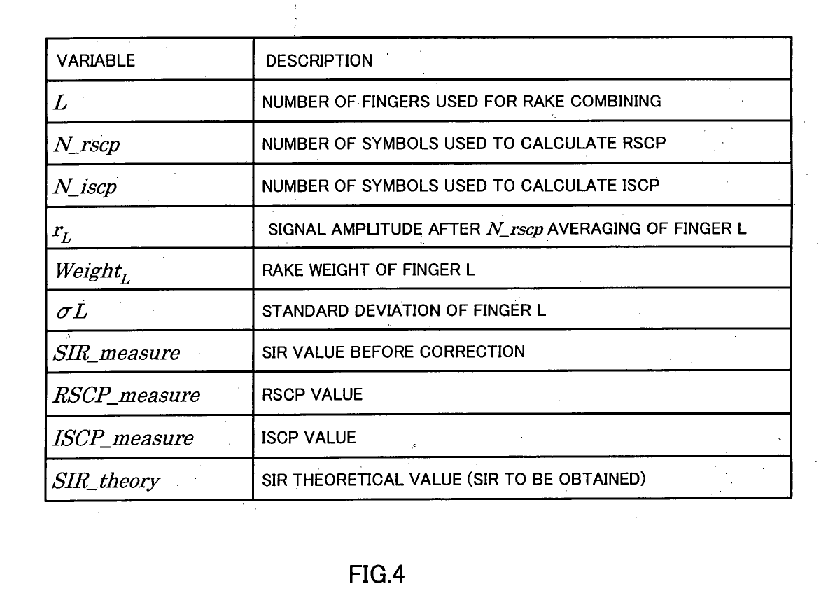

Next, the operation of the SIR measuring apparatus 100 of this embodiment will be explained. FIG. 4 summarizes variables used in the expressions which will be explained below. In the following explanations, for brevity of calculation expressions, suppose the respective fingers have the same received power.

Assuming that the respective fingers have the same received power, the following expressions hold:
r₁²= . . . =r_{L}², σ₁²= . . . =σ_{L}² (7)
Weight₁= . . . =Weight_{L} (8)

First, the operation of the RSCP calculation will be explained. RSCP is calculated from the square of the mean value of a received signal. A variance after averaging by averaging number N_rscp becomes 1/(N_rscp) compared to the variance before averaging. That is, even if averaging processing corresponding to N_rscp number is performed, σ_{L}²/N_rscp is included as the residual variance component.

Therefore, the RSCP value after RAKE combining calculated by the RAKE RSCP calculation section 131 is expressed by the following expression:

$$\begin{matrix}{RSCP}_{—} measure = & \{ {Weight}_{1} ( {r}_{1} + \sqrt{\frac{1}{{N}_{—} rscp}} {σ}_{1} ) + … + \\ & { {Weight}_{L} ( {r}_{L} + \sqrt{\frac{1}{{N}_{—} rscp}} {σ}_{L} ) \}}^{2} \\ = & {\{ L \cdot {Weight}_{L} \cdot ( {r}_{L} + \sqrt{\frac{1}{{N}_{—} rscp}} {σ}_{L} ) \}}^{2}\end{matrix} \qquad ( 9 )$$

Since desired signal components are added with the same phase by RAKE combining, the RAKE RSCP calculation section 131 performs an addition in the dimension of the amplitude as shown in Expression (9) and squares the addition results.

Next, the ISCP calculation operation will be explained. The ISCP is given as a variance of the received signal. Furthermore, the variance after averaging by the averaging number N_iscp becomes (N_iscp-1)/N_iscp times the variance of the received signal before averaging. Therefore, the ISCP value after RAKE combining calculated by the RAKE ISCP calculation section 132 is expressed by the following expression:

$$\begin{matrix}{ISCP}_{—} measure = & {Weight}_{1}^{2} {σ}_{1}^{2} \frac{{N}_{—} iscp - 1}{{N}_{—} iscp} + … + \\ & {Weight}_{L}^{2} {σ}_{L}^{2} \frac{{N}_{—} iscp - 1}{{N}_{—} iscp} \\ = & L \cdot {Weight}_{L}^{2} \cdot {σ}_{L}^{2} \cdot \frac{{N}_{—} iscp - 1}{{N}_{—} iscp}\end{matrix} \qquad ( 10 )$$

Unlike the desired signal component shown in Expression (9), the RAKE combining of the interference signal component shown in Expression (10) is added up in the dimension of power. In the above explanations, RAKE weights are used when RAKE combining is carried out, but in the case of a combination without RAKE weights, Weight_{L}=1 can be assumed.

From Expressions (9) and (10), the SIR value when no correction is performed is expressed by the following expression:

$$SIR\_ measure = \frac{{RSCP}_{—} measure}{{ISCP}_{—} measure} = \frac{{\{ L \cdot {Weight}_{L} \cdot ( {r}_{L} + \sqrt{\frac{1}{{N}_{—} rscp}} {σ}_{L} ) \}}^{2}}{L \cdot {Weight}_{L}^{2} \cdot {σ}_{L}^{2} \cdot \frac{{N}_{—} iscp - 1}{{N}_{—} iscp}} \qquad ( 11 )$$

Here, the ensemble mean value of the SIR(D4) calculated by the SIR calculation section 130 is calculated by the following expression:

$$\begin{matrix}\overline{{SIR}_{—} measure} = & \frac{\overline{{\{ L \cdot {Weight}_{L} \cdot ( {r}_{L} + \sqrt{\frac{1}{{N}_{—} rscp}} {σ}_{L} ) \}}^{2}}}{\overline{L \cdot {Weight}_{L}^{2} \cdot {σ}_{L}^{2} \cdot \frac{{N}_{—} iscp - 1}{{N}_{—} iscp}}} = \\ & \frac{{L}^{2} \cdot {Weight}_{L}^{2} \cdot ( {r}_{L}^{2} + \frac{1}{{N}_{—} rscp} {σ}_{L}^{2} )}{L \cdot {Weight}_{L}^{2} \cdot {σ}_{L}^{2} \cdot \frac{{N}_{—} iscp - 1}{{N}_{—} iscp}} \\ = & \frac{L \cdot ( {r}_{L}^{2} + \frac{1}{{N}_{—} iscp} {σ}_{L}^{2} )}{{σ}_{L}^{2} \frac{{N}_{—} iscp - 1}{{N}_{—} iscp}}\end{matrix} \qquad ( 12 )$$

On the other hand, the SIR value to be calculated is expressed by the following expression:

$$SIR\_ theory = \frac{{( {Weight}_{1} \cdot {r}_{1} + … + {Weight}_{L} \cdot {r}_{L} )}^{2}}{{Weight}_{1}^{2} \cdot {σ}_{1}^{2} + … + {Weight}_{L}^{2} \cdot {σ}_{L}^{2}} = \frac{L \cdot {r}_{L}^{2}}{{σ}_{L}^{2}} \qquad ( 13 )$$

Therefore, from Expression (13), r_{L}² is expressed by the following expression:

$${r}_{L}^{2} = \frac{{SIR}_{—} theory \cdot {σ}_{L}^{2}}{L} \qquad ( 14 )$$

Here, substitution of Expression (14) into Expression (12) obtains the following expression:

$$\overline{{SIR}_{—} measure} = \frac{( {SIR}_{—} theory + \frac{L}{{N}_{—} rscp} ) {σ}_{L}^{2}}{{σ}_{L}^{2} \frac{{N}_{—} iscp - 1}{{N}_{—} iscp}} = \frac{( {SIR}_{—} theory + \frac{L}{{N}_{—} rscp} )}{\frac{{N}_{—} iscp - 1}{{N}_{—} iscp}} \qquad ( 15 )$$

Therefore, if the SIR value to be calculated is expressed using the SIR value before correction, the SIR value is expressed by the following expression:

$${SIR}_{—} theory = \overline{{SIR}_{—} measure} \cdot \frac{{N}_{—} iscp - 1}{{N}_{—} iscp} - \frac{L}{{N}_{—} rscp} \qquad ( 16 )$$

Considering this, the SIR correction section 140 of this embodiment carries out the following correction calculation as shown in the following expression on an SIR value (SIR_measure) before correction and calculates an SIR after correction to thereby eliminate a static error with respect to an SIR theoretical value (SIR_theory).

$$Corrected S IR = SIR\_ measure \cdot \frac{N\_iscp - 1}{N\_iscp} - \frac{L}{N\_rscp} \cdot α \qquad ( 17 )$$

That is, the SIR correction section 140 carries out correction processing using the number of symbols used to calculate RSCP (that is, number of discrete signals such as known signals used to calculate RSCP) N_rscp, the number of symbols used to calculate ISCP (that is, number of discrete signals such as known signals used to calculate ISCP) N_iscp and the number of fingers L used for RAKE combining. As a result, the SIR correction section 140 can calculate a correction SIR(D5) which has resolved a static error with respect to the SIR theoretical value (SIR_theory).

Furthermore, as is evident from Expression (17), the SIR correction section 140 is designed to use both the number of discrete signals N_rscp such as known signals used to calculate RSCP and the number of discrete signals N_iscp such as known signals used to calculate ISCP independently of each other for corrections. Therefore, even when the number of discrete signals N_rscp such as known signals used to calculate RSCP differs from the number of discrete signals N_iscp such as known signals used to calculate ISCP, it is possible to calculate a correction SIR(D5) with high accuracy. As a result, it is possible to realize SIR measurements with a high degree of freedom independently of the number of signals measured. More specifically, it is possible to increase the degree of freedom in the apparatus configuration of the RSCP calculation section 110 and ISCP calculation section 120.

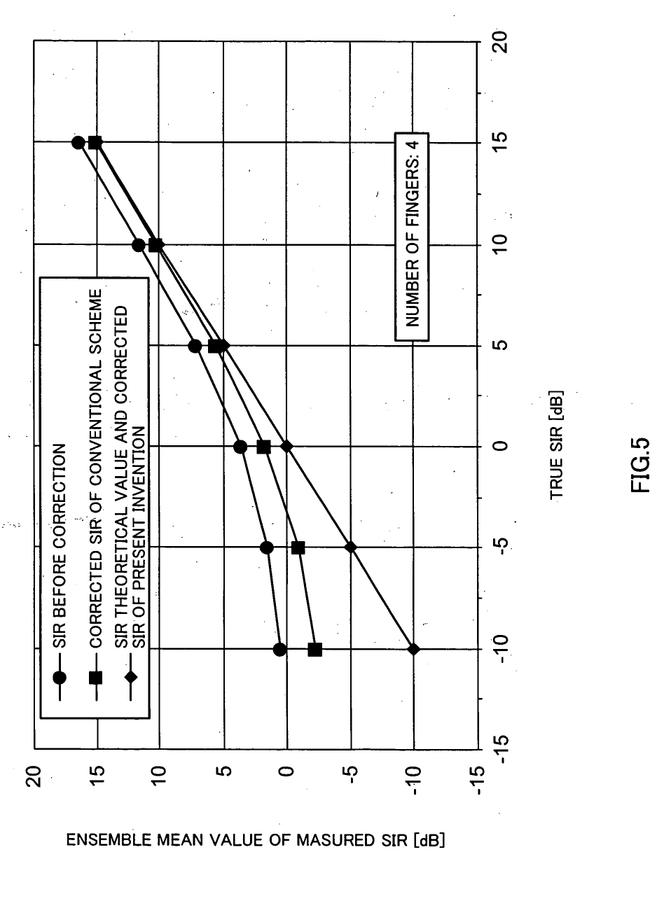

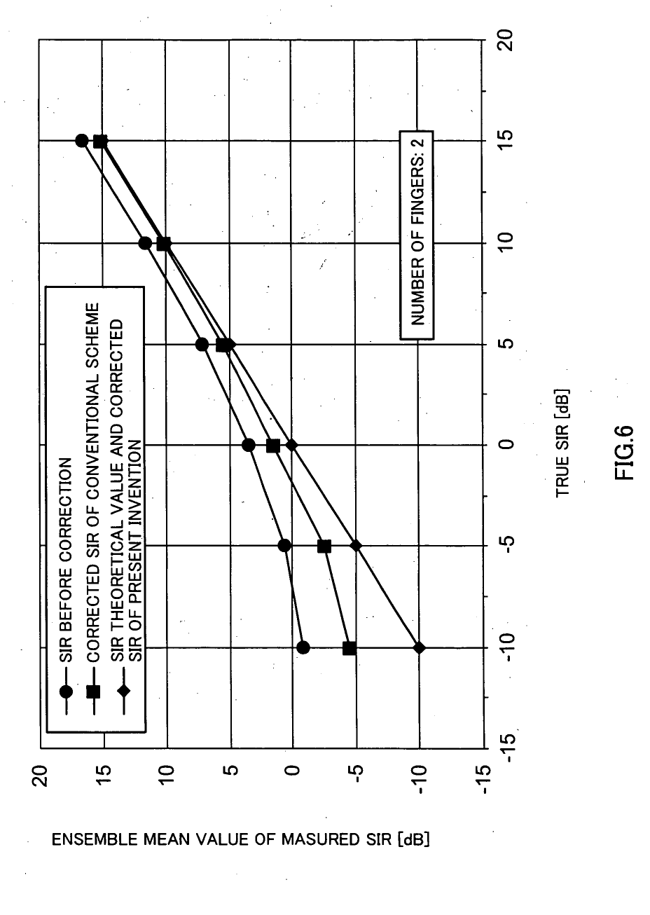

FIG. 5 and FIG. 6 show the results of experiments making a comparison between an SIR before correction, SIR after correction using a conventional technique and SIR(D5) after correction according to the present invention when the number of fingers is 4 and 2. As is evident from FIG. 5 and FIG. 6, in the conventional correction method, the SIR after correction (lines with square dots in the figure) does not match the SIR theoretical value, which shows that a correction is not made correctly. On the other hand, the present invention can perform a correction so that the SIR before correction (lines with round dots in the figure) matches the SIR theoretical value (lines with rhombic dots in the figure).

In this way, according to the configuration of this embodiment, an SIR (SIR_measure) after RAKE combining calculated from a desired signal power value for each finger and an interference signal power value for each finger is corrected using the number of discrete signals N_rscp used to calculate RSCP, the number of discrete signals N_iscp used to calculate ISCP and the number of fingers L used for RAKE combining, and therefore even when the number of discrete signals used to calculate RSCP is different from the number of discrete signals used to calculate ISCP, it is possible to realize the SIR measuring apparatus 100 capable of resolving a static error with respect to a theoretical value and realizing measurements with high accuracy and a high degree of freedom.

### Embodiment 2

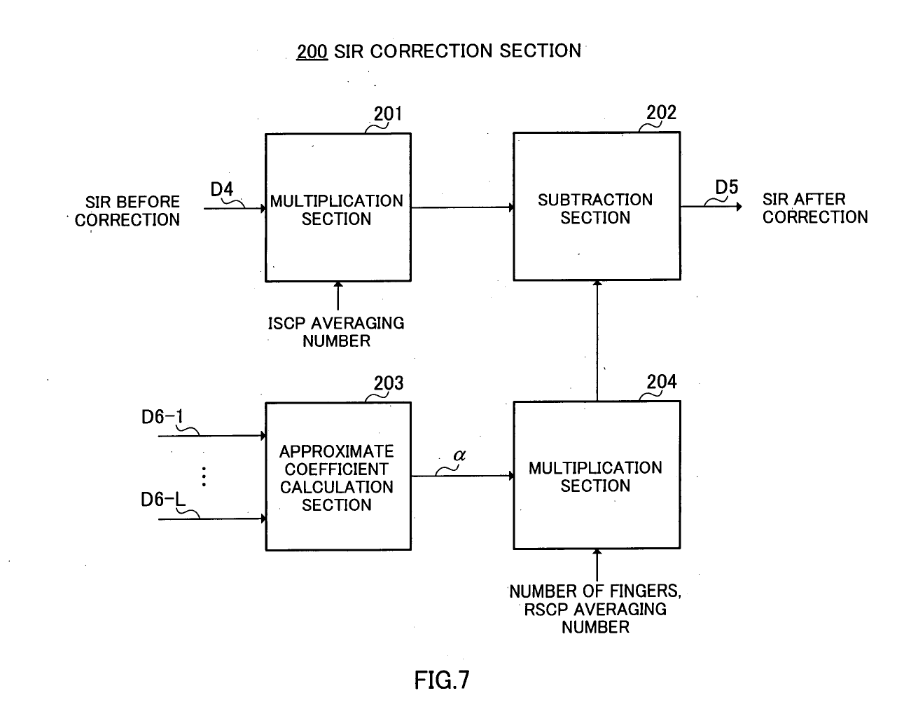

FIG. 7 shows the configuration of an SIR correction section 200 according to Embodiment 2 of the present invention. That is, this embodiment uses the SIR correction section 200 in FIG. 7 instead of the SIR correction section 140 in FIG. 3 explained in Embodiment 1. This embodiment differs from Embodiment 1 only in the SIR correction section 200, and therefore only the SIR correction section 200 will be explained.

The SIR correction section 200 includes an approximate coefficient calculation section 203 and a multiplication section 204. The approximate coefficient calculation section 203 receives received powers D6-1 to D6-L of their respective fingers and the approximate coefficient calculation section 203 calculates approximate coefficient a corresponding to the ratio of the received power of each finger. This approximate coefficient a is sent to the multiplication section 204. The multiplication section 204 carries out a multiplication using the number of fingers L used for RAKE combining, averaging number used to calculate RSCP and approximate coefficient a and sends the multiplication result to a subtraction section 202.

As in the case of the multiplication section 141 in Embodiment 1, a multiplication section 201 multiplies an SIR value D4 before correction by a value corresponding to an averaging number value used to calculate ISCP. The subtraction section 202 subtracts the output value of the multiplication section 204 from the SIR value multiplied by the ISCP averaging number by the multiplication section 201. Compared to the SIR correction section 140 in Embodiment 1, this makes it possible to measure SIR(D5) with high accuracy even if the received powers D6-1 to D6-L differ from one finger to another.

Next, the operation of the SIR correction section of this embodiment will be explained. On the input SIR(D4) before correction, the SIR correction section 200 performs a correction expressed by the following expression using approximate coefficient a:

$${SIR}_{—} theory = {SIR}_{—} measure \cdot \frac{{N}_{—} iscp - 1}{{N}_{—} iscp} - \frac{L}{{N}_{—} rscp} \cdot α \qquad ( 18 )$$

This correction will be explained. First, as opposed to the case explained in Embodiment 1 where the received power is common to all fingers, a case where their received powers are different will be explained. For example, in the case of two fingers, suppose there is a difference in the received power between the fingers. When the difference increases, sizes of small paths will finally be negligible to large paths and the number of fingers can be approximated to 1.

That is, when the received powers are not equal, the number of fingers L in Expression (17) must approximate from 2 to 1 and the number of fingers L is too large. Therefore, using the approximate coefficient a (1/L≦α≦1) corresponding to the ratio of the received power of each finger, a correction expressed by Expression (18) is carried out. Here, the approximate coefficient a can take any value provided that the maximum value thereof is 1 and the approximate coefficient α corresponds to the ratio of the received power of each finger. Furthermore, when it is difficult to measure the received power of each finger and change the approximate coefficient α when necessary, the approximate coefficient α may be set to a fixed value.

Thus, according to the configuration of this embodiment, an SIR (SIR_measure) after RAKE combining calculated from a desired signal power value for each finger and an interference signal power value for each finger is corrected using approximate coefficient α corresponding to the ratio of the received power of each finger in addition to the number of discrete signals N_rscp used to calculate RSCP and the number of discrete signals N_iscp used to calculate ISCP and the number of fingers L used for RAKE combining, and therefore in addition to the effect of Embodiment 1, this embodiment has the effect of reducing a static error with respect to a theoretical value no matter what the received power at each finger may be.

The above described embodiments have explained the case where the present invention is implemented using a hardware configuration shown in FIG. 1 to FIG. 3, FIG. 7, but the functions shown in FIG. 1 to FIG. 3, FIG. 7 may also be implemented by a program.

The present invention is not limited to the above described embodiments, but can also be implemented modified in various ways.

A mode of the SIR measuring apparatus of the present invention adopts a configuration including a desired signal power calculation section that calculates desired signal power for each finger, an interference signal power calculation section that calculates interference signal power for each finger, an SIR calculation section that calculate an SIR after RAKE combining from the calculated desired signal power value for each finger and interference signal power value for each finger and an SIR correction section that corrects the SIR calculated by the SIR calculation section according to the number of discrete signals used to calculate the desired signal power value for each finger, the number of discrete signals used to calculate the interference signal power value for each finger and the number of fingers for carrying out RAKE combining.

According to this configuration, the SIR correction section corrects the SIR after RAKE combining calculated from the desired signal power value for each finger and interference signal power value for each finger according to the number of discrete signals used to calculate the desired signal power value for each finger, the number of discrete signals used to calculate the interference signal power value for each finger and the number of fingers for carrying out RAKE combining, and therefore it is possible to measure the SIR after RAKE combining at a high degree of accuracy. Furthermore, when correction processing is carried out, the number of discrete signals used to calculate the desired signal power value for each finger and the number of discrete signals used to calculate the interference signal power value for each finger are independently reflected, which increases the degree of freedom in measurements and configuration of the apparatus.

Another mode of the SIR measuring apparatus of the present invention adopts a configuration correcting an SIR after RAKE combining calculated from a desired signal power value for each finger and interference signal power value for each finger using an approximate coefficient corresponding to the ratio of the received power of each finger in addition to the number of discrete signals used to calculate the desired signal power value for each finger, the number of discrete signals used to calculate the interference signal power value for each finger and the number of fingers for carrying out RAKE combining.

According to this configuration, the SIR after RAKE combining is corrected using an approximate coefficient a corresponding to the ratio of the received power of each finger in addition to the above described configuration, and therefore the SIR after RAKE combining can be measured at a high degree of accuracy no matter what the received power at each finger may be.

As described above, the present invention can measure the SIR after RAKE combining at a high degree of accuracy and realize an SIR measuring apparatus and a method thereof with a high degree of freedom in measurements.

This application is based on the Japanese Patent Application No. 2003-159726 filed on Jun. 4, 2003, entire content of which is expressly incorporated by reference herein.

### INDUSTRIAL APPLICABILITY

The present invention is preferably applicable to a radio communication apparatus carrying out RAKE combining.

1. An SIR measuring apparatus comprising:
a desired signal power calculation section that calculates desired signal power for each finger;
an interference signal power calculation section that calculates interference signal power for each finger;
an SIR calculation section that calculate an SIR after RAKE combining from the calculated desired signal power value for each finger and interference signal power value for each finger; and
an SIR correction section that corrects the SIR calculated by said SIR calculation section according to the number of discrete signals used to calculate said desired signal power value for each finger, the number of discrete signals used to calculate said interference signal power value for each finger and the number of fingers for carrying out RAKE combining.

2. The SIR measuring apparatus according to claim 1, wherein said SIR correction section calculates an SIR value after correction using the following expression:
$$Corrected SIR = {SIR}_{—} measure \cdot \frac{{N}_{—} iscp - 1}{{N}_{—} iscp} - \frac{L}{{N}_{—} rscp}$$
where SIR_measure is the SIR before correction calculated by said SIR calculation section, N_rscp is the number of discrete signals used to calculate said desired signal power for each finger, N_iscp is the number of discrete signals used to calculate said interference signal power for each finger and L is the number of fingers used for RAKE combining.

3. The SIR measuring apparatus according to claim 1, wherein said SIR correction section calculates an SIR value after correction using the following expression:
$$Corrected SIR = {SIR}_{—} measure \cdot \frac{{N}_{—} iscp - 1}{{N}_{—} iscp} - \frac{L}{{N}_{—} rscp} \cdot α$$
where SIR_measure is the SIR before correction calculated by said SIR calculation section, N_rscp is the number of discrete signals used to calculate said desired signal power for each finger, N_iscp is the number of discrete signals used to calculate said interference signal power for each finger, L is the number of fingers used for RAKE combining and α (≦1) is an approximate coefficient which is changed according to the received power of each finger.

4. An SIR measuring method comprising the steps of:
calculating desired signal power for each finger;
calculating interference signal power for each finger;
calculating an SIR after RAKE combining from the calculated desired signal power value for each finger and interference signal power value for each finger; and
correcting said SIR according to the number of discrete signals used to calculate said desired signal power value for each finger, the number of discrete signals used to calculate said interference signal power value for each finger and the number of fingers for carrying out RAKE combining.

5. A program for causing a computer to execute:
a step of calculating desired signal power for each finger;
a step of calculating interference signal power for each finger;
a step of calculating an SIR after RAKE combining from the calculated desired signal power value for each finger and interference signal power value for each finger; and
a step of correcting said SIR according to the number of discrete signals used to calculate said desired signal power value for each finger, the number of discrete signals used to calculate said interference signal power value for each finger and the number of fingers for carrying out RAKE combining.
